(19) United States
(12) Patent Application Publication
(10) Pub. No.: US 2011/0073800 A1
(43) Pub. Date: Mar. 31, 2011

(54) Abrasive-free chemical mechanical polishing compositions

(76) Inventors: Hongyu Wang, Wilmington, DE (US); Scott A. Ibbitson, Trappe, PA (US); Tirthankar Ghosh, Oreland, PA (US); Mark R. Winkle, Lansdale, PA (US)

(21) Appl. No.: 12/586,642

(22) Filed: Sep. 25, 2009

(51) Int. Cl. C09K 13/00

(52) U.S. Cl. 252/79.1

(57) ABSTRACT

The aqueous abrasive-free composition is useful for chemical mechanical polishing of a patterned semiconductor wafer containing a nonferrous metal. The composition includes an oxidizer, an inhibitor for the nonferrous metal, 0 to 15 weight percent water soluble modified cellulose, 0 to 15 weight percent phosphorus compound, 0.005 to 5 weight percent of an acidic polymer, and water. The acidic polymer has a methacrylic acid portion having a carbon number of 4 to 250. The methacrylic acid portion includes either methacrylic acid or an acrylic acid/methacrylic acid copolymer. The acidic polymer including a segment from a mercapto-carboxylic acid chain transfer agent.

### BACKGROUND OF THE INVENTION

The invention relates to chemical mechanical polishing (CMP) of semiconductor wafer materials and, more particularly, to CMP compositions and methods for polishing metal interconnects on semiconductor wafers in the presence of dielectrics and barrier materials.

Typically, a semiconductor wafer is a wafer of silicon with a dielectric layer containing multiple trenches arranged to form a pattern for circuit interconnects within the dielectric layer. The pattern arrangements usually have a damascene structure or dual damascene structure. A barrier layer covers the patterned dielectric layer and a metal layer covers the barrier layer. The metal layer has at least sufficient thickness to fill the patterned trenches with metal to form circuit interconnects.

CMP processes often include multiple polishing steps. For example, a first step removes excess interconnect metals, such as copper at an initial high rate. After the first step removal, a second step polishing can remove metal that remains on the barrier layer outside of the metal interconnects. Subsequent polishing removes the barrier from an underlying dielectric layer of a semiconductor wafer to provide a planar polished surface on the dielectric layer and the metal interconnects.

The metal in a trench or trough on the semiconductor substrate provides a metal line forming a metal circuit. One of the problems to be overcome is that the polishing operation tends to remove metal from each trench or trough, causing recessed dishing of such metal. Dishing is undesirable as it causes variations in the critical dimensions of the metal circuit. To reduce dishing, polishing is performed at a lower polishing pressure. However, merely reducing the polishing pressure would require that polishing continue for a lengthened duration; and dishing would continue to be produced for the entire lengthened duration.

Ghosh et al., in U.S. Pat. No. 7,435,356, disclose a method of using amphiphilic polymer for abrasive-free polishing formulations. These formulations limit copper dishing and facilitate acceptable copper clearing with reasonable polishing times. As the number of copper layers per wafer increases, there is a continuing need for abrasive-free formulations that facilitate reduced copper dishing with decreased polishing times. Furthermore, there continues to be a need for polishing compositions that leave a surface clear of interconnect metal residue with ever decreasing polishing times.

### STATEMENT OF THE INVENTION

The invention provides an aqueous abrasive-free composition useful for chemical mechanical polishing of a patterned semiconductor wafer containing a nonferrous metal comprising an oxidizer, an inhibitor for the nonferrous metal, 0 to 15 weight percent water soluble modified cellulose, 0 to 15 weight percent phosphorus compound, 0.005 to 5 weight percent of an acidic polymer, the acidic polymer having a methacrylic acid portion, the methacrylic acid portion having a carbon number of 4 to 250, the methacrylic acid portion including either methacrylic acid or an acrylic acid/methacrylic acid copolymer, the acidic polymer including a segment from a chain transfer agent, the chain transfer agent being a mercapto-carboxylic acid, and water.

In another aspect of the invention, the invention provides an aqueous abrasive-free composition useful for chemical mechanical polishing of a patterned semiconductor wafer containing a nonferrous metal comprising 0.1 to 25 weight percent oxidizer, 0.05 to 15 weight percent inhibitor for the nonferrous metal, 0.01 to 5 weight percent water soluble modified cellulose, 0.01 to 10 weight percent phosphorus compound, 0.01 to 3 weight percent of an acidic polymer, the acidic polymer having a methacrylic acid portion, the methacrylic acid portion having a carbon number of 7 to 100, the methacrylic acid portion including either methacrylic acid or an acrylic acid/methacrylic acid copolymer, the acidic polymer having a weight average molecular weight of 200 to 6,000 and including a segment from a chain transfer agent, the chain transfer agent being a mercapto-carboxylic acid, and water.

### DETAILED DESCRIPTION

The composition and method increase metal removal rates, provide effective metal clearing all with low metal interconnect dishing. The composition uses either an acidic polymer of methacrylic acid or an acrylic acid/methacrylic acid copolymer with a segment from a mercapto-carboxylic acid transfer agent to polish semiconductors. Optionally, the composition may contain a water soluble modified cellulose and a phosphorus compound. The solution is abrasive-free and does not require any abrasive.

The acidic polymers referred to in this specification are either methacrylic acid polymers or copolymers comprised of methacrylic and acrylic acid segments with segment from a mercapto-carboxylic acid transfer agent. The acidic polymer can have polymeric chains with a carbon number varying from 4 to 250. For purposes of this specification, carbon number represents the number of carbon atoms in the copolymer portion. Preferably, the carbon number is 7 to 100 and most preferably, 10 to 50. The number of monomeric units in the methacrylic acid polymer varies from 1 to 100; and the copolymer portion preferably varies from 2 to 100. Advantageously, the composition contains 0.005 to 5 weight percent of the acidic copolymer. Preferably, the composition contains 0.01 to 3 weight percent of the acidic copolymer. Most preferably, the composition contains 0.05 to 2 weight percent of the acidic copolymer.

The acidic polymer's preferred number average molecular weight is 170 to 7,500—this specification refers to a polymer's molecular weight in terms of number average molecular weight. More preferably, the number average molecular weight is between 200 and 6,000 and most preferably the number average molecular weight is between 500 and 5,000. Optional ionic segments include cationic, anionic, and zwitterions (polyampholytes and polybetaines). The acidic copolymer includes a copolymer of acrylic acid and methacrylic acid prepared with a chain transfer agent. The combining of these segments into a copolymer produces molecules with properties different than their respective homopolymers that facilitate clearing without excessive dishing of metal interconnects.

The chain transfer agent is mercapto-carboxylic acid. The mercapto-carboxylic acid provides an unexpected increase in copper removal rate. Most preferably, the chain transfer agent is 3-mercaptopropionic acid.

Although the present invention has particular usefulness in copper interconnects, the present aqueous polishing composition also provides enhanced polishing of other nonferrous metal interconnects, such as aluminum, gold, nickel, platinum group metals, silver, tungsten, and alloys thereof.

Optionally, the composition contains 0 to 15 water soluble cellulose. Preferably, the composition contains 0.01 to 5.0 weight percent of water soluble cellulose. Most preferably, the composition contains 0.05 to 1.5 weight percent of water soluble cellulose. Exemplary modified cellulose are anionic gums such as at least one of agar gum, arabic gum, ghatti gum, karaya gum, guar gum, pectin, locust bean gum, tragacanth gums, tamarind gum, carrageenan gum, and xantham gum, modified starch, alginic acid, mannuronic acid, guluronic acid, and their derivatives and copolymers. The preferred water soluble cellulose, carboxy methyl cellulose (CMC), has a degree of substitution of 0.1 to 3.0 with a weight average molecular weight of 1K to 1,000K. More preferred, the CMC has a degree of substitution of 0.7 to 1.2 with a weight average molecular weight of 40K to 250K. Degree of substitution in CMC is the number of hydroxyl groups on each anhydroglucose unit in the cellulose molecule that is substituted. It can be considered as a measure of the “density” of carboxylic acid groups in the CMC.

The solution contains an oxidizer. Preferably, the solution contains 0.1 to 25 weight percent oxidizer. More preferably, the oxidizer is in the range of 5 to 10 weight percent. The oxidizer is particularly effective at assisting the solution in removing copper at low pH ranges. The oxidizing agent can be at least one of a number of oxidizing compounds, such as hydrogen peroxide (H₂O₂), monopersulfates, iodates, magnesium perphthalate, peracetic acid and other per-acids, persulfates, bromates, periodates, nitrates, iron salts, cerium salts, Mn (III), Mn (IV) and Mn (VI) salts, silver salts, copper salts, chromium salts, cobalt salts, halogens, hypochlorites and a mixture thereof. Furthermore, it is often advantageous to use a mixture of oxidizer compounds. When the polishing slurry contains an unstable oxidizing agent such as, hydrogen peroxide, it is often most advantageous to mix the oxidizer into the composition at the point of use.

Further, the solution contains an inhibitor to control removal of nonferrous metal, such as, copper interconnect removal rate by static etch or other removal mechanism. Adjusting the concentration of an inhibitor adjusts the interconnect metal removal rate by protecting the metal from static etch. Preferably, the solution contains 0.05 to 15 weight percent inhibitor. Most preferably, the solution contains 0.2 to 1.0 weight percent inhibitor. The inhibitor may consist of a mixture of inhibitors. Azole inhibitors are particularly effective for copper and silver interconnects. Typical azole inhibitors include benzotriazole (BTA), mercaptobenzothiazole (MBT), tolytriazole (TTA) and imidazole. Blends of azole inhibitors can increase or decrease copper removal rate. BTA is a particularly effective inhibitor for copper and silver.

In addition to the inhibitor, the composition optionally contains complexing agent for the nonferrous metal. The complexing agent may facilitate the removal rate of the metal film, such as copper. Preferably, the composition contains 0 to 15 weight percent complexing agent for the nonferrous metal. Most preferably, the composition contains 0.1 to 1 weight percent complexing agent for the nonferrous metal. Example complexing agents include acetic acid, citric acid, ethyl acetoacetate, glycolic acid, iminodiacetic acid, lactic acid, malic acid, oxalic acid, salicylic acid, sodium diethyl dithiocarbamate, succinic acid, tartaric acid, thioglycolic acid, glycine, alanine, aspartic acid, ethylene diamine, trimethyl diamine, malonic acid, gluteric acid, 3-hydroxybutyric acid, propionic acid, phthalic acid, isophthalic acid, 3-hydroxy salicylic acid, 3,5-dihydroxy salicylic acid, gallic acid, gluconic acid, pyrocatechol, pyrogallol, tannic acid, including, salts and mixtures thereof. Preferably, the complexing agent is selected from the group consisting of acetic acid, citric acid, ethyl acetoacetate, glycolic acid, iminodiacetic acid, lactic acid, malic acid, oxalic acid and mixtures thereof. Most preferably, the complexing agent is malic acid with iminodiacetic acid.

Optionally, the composition includes 0 to 15 phosphorous-containing compound. For purposes of this specification, a “phosphorus-containing” compound is any compound containing a phosphorus atom. A preferred phosphorus-containing compound is, for example, a phosphate, pyrophosphate, polyphosphate, phosphonate, including, their acids, salts, mixed acid salts, esters, partial esters, mixed esters, and mixtures thereof, for example, phosphoric acid. In particular, a preferred aqueous polishing composition can be formulated using, for example, the following phosphorus-containing compounds: zinc phosphate, zinc pyrophosphate, zinc polyphosphate, zinc phosphonate, triammonium phosphate, diammonium hydrogen phosphate, ammonium dihydrogen phosphate, ammonium pyrophosphate, ammonium polyphosphate, ammonium phosphonate, diammonium phosphate, diammonium pyrophosphate, diammonium polyphosphate, diammonium phosphonate, guanidine phosphate, guanidine pyrophosphate, guanidine polyphosphate, guanidine phosphonate, iron phosphate, iron pyrophosphate, iron polyphosphate, iron phosphonate, cerium phosphate, cerium pyrophosphate, cerium polyphosphate, cerium phosphonate, ethylene-diamine phosphate, piperazine phosphate, piperazine pyrophosphate, piperazine phosphonate, melamine phosphate, dimelamine phosphate, melamine pyrophosphate, melamine polyphosphate, melamine phosphonate, melam phosphate, melam pyrophosphate, melam polyphosphate, melam phosphonate, melem phosphate, melem pyrophosphate, melem polyphosphate, melem phosphonate, dicyanodiamide phosphate, urea phosphate, including, their acids, salts, mixed acid salts, esters, partial esters, mixed esters, and mixtures thereof. Also, phosphine oxides, phosphine sulphides and phosphorinanes and of phosphonates, phosphites and phosphinates may be used, including, their acids, salts, mixed acid salts, esters, partial esters and mixed esters. A preferred phosphorus-containing compound is diammonium hydrogen phosphate or ammonium dihydrogen phosphate.

Advantageously, the phosphorus-containing compound of the polishing composition of the present invention is present in an amount effective to increase polishing rates at low down force pressures. It is believed that even a trace amount of the phosphorus-containing compound in the polishing composition is effective for polishing the copper. A satisfactory polishing rate at acceptable polishing down force pressures is obtained by using the phosphorus-containing compound in an amount of 0.01 to 10 weight percent of the composition. A preferred range for the phosphorus-containing compound is 0.1 to 5 weight percent of the composition. Most preferably, the phosphorus-containing compound is 0.3 to 2 weight percent of the composition.

The compounds provide efficacy over a broad pH range in solutions containing a balance of water. This solution's useful pH range extends from at least 2 to 5. In addition, the solution preferably relies upon a balance of deionized water to limit incidental impurities. The pH of the polishing fluid of this invention is preferably from 2 to 4.5, more preferably a pH of 2.5 to 4. The acids used to adjust the pH of the composition of this invention are, for example, nitric acid, sulfuric acid, hydrochloric acid, phosphoric acid and the like. Exemplary bases used to adjust the pH of the composition of this invention are, for example, ammonium hydroxide and potassium hydroxide.

The composition of the present invention is applicable to any semiconductor wafer containing a conductive metal, such as copper, aluminum, tungsten, platinum, palladium, gold, or iridium; a barrier or liner film, such as tantalum, tantalum nitride, titanium, or titanium nitride; and an underlying dielectric layer. For purposes of the specification, the term dielectric refers to a semi-conducting material of dielectric constant, k, which includes low-k and ultra-low k dielectric materials. The composition and method are excellent for preventing erosion of multiple wafer constituents, for example, porous and nonporous low-k dielectrics, organic and inorganic low-k dielectrics, organic silicate glasses (OSG), fluorosilicate glass (FSG), carbon doped oxide (CDO), tetraethylorthosilicate (TEOS) and a silica derived from TEOS. The compositions of this invention may also be used for ECMP (Electrochemical Mechanical Polishing).

### EXAMPLES

Some embodiments of the invention will now be described in detail in the following Examples. In these examples, weight percent solids for the copolymer compositions were determined by gravimetric analysis. Number average molecular weight was determined by aqueous gel permeation chromatography using TSK-GEL pn/08025 GMPWx and TSK-GEL pn/08020 G2500PWx columns in series with a refractive index detector and sodium phosphate buffer eluent.

### Example 1

### Preparation of 3-MPA MAA/AA Copolymer

The polymerization was conducted in a 1-liter, four neck round bottom reaction flask equipped with a mechanical stirrer, temperature control device, condenser, monomer feed line, catalyst feed line, and nitrogen sweep. These ingredients were added according to the following procedure.

### Copolymer Composition (Parts by Weight) MAA/AA/DI H₂O/3-MPA (60/40/9)

Monomer Mix 180

| Ingedient) | Calculated Weight. (g) | Actual Weight. (g) |
|---|---|---|
| MAA | 180 | 180.10 |
| AA | 120 | 120.30 |
| DI H₂O | 150 | 150.00 |
| 3-MPA | 27 | 27.20 |

MMA = methacrylic acid, AA = polyacrylic acid, DI = deionized and 3-MPa = 3-mercaptopropionic acid

Initiator Mix

| Ingedient | Calculated Weight. (g) | Actual Weight. (g) |
|---|---|---|
| DI H₂O | 137.01 | 137.00 |
| VAZO68WSP | 6.00 | 6.20 |
| Ammonium Hydroxide | 22.5 | 22.70 |

Vazo®68WSP:
dry white powder initiator from E.I. DuPont de Nemours and Company with a formulation as follows:

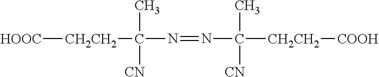

Heel Charge

| Ingedient | Calculated Weight. (g) | Actual Weight. (g) |
|---|---|---|
| DI H₂O | 700 | 700.00 |

Shot Chase

| Ingedient | Calculated Weight. (g) | Actual Weight. (g) |
|---|---|---|
| VAZO68WSP | 1.5 | 1.50 |

Extra Solvent Addition Monomer Pump Rinse

| Ingedient | Calculated Weight. (g) | Actual Weight. (g) |
|---|---|---|
| DI H₂O | 180 | Balance |

### Total Batch Weight 1500.00 g

Process

| Temp | |
|---|---|
| (° C.) | Description |
| 25 | Inert with nitrogen. Charge heel to 1 L flask. Heat to 85° C. |
| 85 | Add extra solvent addition to monomer reservoir to rinse pump |
| 85 | After feed is complete, hold at 85° C. for 120 min. |
| 85/60 | Batch complete. Allow batch to cool to approximately 60° C. |

The number average molecular weight was determined by aqueous gel permeation chromatography to be 2580.

### Example 2

### Polishing Rate

In this Examples, all compositions contain, by weight percent, 0.50 BTA, 0.22 malic acid, 0.32 carboxymethylcellulose (CMC), 0.10 various acidic polymer and copolymers, 0.44 ammonium phosphate, and 9.00 hydrogen peroxide at a pH of 3.5—pH adjusted with nitric acid with a balance deionized water. An Applied Materials, Inc. Mirra™ 200 mm polishing machine using an IC1010™ polyurethane polishing pad (Dow Electronic Materials) under downforce conditions of about 1.5 psi (10.4 kPa) and a polishing solution flow rate of 150 cc/min, a platen speed of 80 RPM and a carrier speed of 75 RPM planarized the wafers. A Kinik diamond abrasive disk conditioned the polishing pad. Solutions A to D represent comparative examples and solutions 1 to 6 represent examples of the invention.

TABLE 1

| | | | | | Cu |
|---|---|---|---|---|---|
| | Chain | | Monomer | Molecular | Removal |
| Polishing | Transfer | Monomer/ | Units | Weight | Rate |
| Solution | Agent | Copolymer | (No.) | (No. Avg.) | (Å/min) |
| A | n-DDM | MAA | 6 | 700 | 4305 |
| B | n-DDM | MAA | 6 | 700 | 4310 |
| C | n-DDM | MAA | 30 | 2580 | 3974 |
| D | n-DDM | MAA/AA | 30 | 2580 | 492 |
| 1 | 3-MPA | MAA | 6 | 2580 | 4178 |
| 2 | 3-MPA | MAA/AA | 30 | 700 | 3668 |

n-DDM = C₁₂H₂₅—SH, 3-MPA = 3-mercaptopropionic acid, MAA = methacrylic acid and AA = acrylic acid.

The above data illustrate that acidic polymers produced with a 3-MPA transfer agent provide excellent removal rates for methacrylic acid and methacrylic acid/polyacrylic acid polymers and copolymers, respectively.

### Example 3

### Dishing/Clearing

TABLE 2

| | Chain | | Monomer | Dishing (Å) |
|---|---|---|---|---|
| Polishing | Transfer | Monomer/ | Units | 100 μm × |
| Solution | Agent | Copolymer | (No.) | 100 μm |
| A | n-DDM | MAA | 6 | 264 |
| B | n-DDM | MAA | 6 | 307 |
| C | n-DDM | MAA | 30 | 284 |
| D | n-DDM | MAA | 30 | 298 |
| 1 | 3-MPA | MAA | 6 | 377 |
| 2 | 3-MPA | MAA/AA | 30 | 248 |

n-DDM = C₁₂H₂₅—SH, 3-MPA = 3-mercaptopropionic acid, MAA = methacrylic acid and AA = acrylic acid.

Table 2 data illustrate that the 3-MPA transfer agent provides acceptable dishing for the 100 μm×100 μm feature on the patterned wafers.

### Example 4

### Polishing Rate

TABLE 3

| | | | | | Cu |
|---|---|---|---|---|---|
| | Chain | | Monomer | Molecular | Removal |
| Polishing | Transfer | Monomer/ | Units | Weight | Rate |
| Solution | Agent | Copolymer | (No.) | (No. Avg.) | (Å/min) |
| 3 | 3-MPA | MAA | 30 | 2805 | 4318 |
| 4 | 3-MPA | MAA | 6 | 1900 | 4159 |
| 5 | 3-MPA | MAA | 15 | 2322 | 4130 |
| 6 | 3-MPA | MAA/AA | 30 | 2632 | 4317 |

3-MPA = 3-mercaptopropionic acid, MAA = methacrylic acid and AA = acrylic acid.

The above data illustrate that acidic polymers produced with a 3-MPA transfer agent provide excellent removal rates for methacrylic acid and methacrylic acid/polyacrylic acid polymers and copolymers, respectively. The higher molecular weight polymers and copolymers tended to have higher removal rate. Polishing solution 6 with 3-MPA shows a significant increase in copper removal rate in comparison to Comparative Example D that included a similar copolymer with an n-DDM transfer agent segment.

### Example 5

### Dishing/Clearing

TABLE 4

| | Chain | | Monomer | Molecular | Dishing (Å) | |
|---|---|---|---|---|---|---|
| Polishing | Transfer | Monomer/ | Units | Weight | 100 μm × | Cu |
| Solution | Agent | Copolymer | (No.) | (No. Avg.) | 100 μm | Residue |
| 3 | 3-MPA | MAA | 30 | 2805 | 862 | Clear |
| 4 | 3-MPA | MAA | 6 | 1900 | 767 | Clear |
| 5 | 3-MPA | MAA | 15 | 2322 | 724 | Clear |
| 6 | 3-MPA | MAA/AA | 30 | 2632 | 806 | Clear |

3-MPA = 3-mercaptopropionic acid, MAA = methacrylic acid and AA = acrylic acid.

The above data illustrate that acidic polymers produced with a 3-MPA transfer agent provide an excellent combination of copper dishing with effective residue clearing. The lower molecular weight formulations tended to reduce copper dishing in comparison to higher molecular weight polymers and copolymers.

As illustrated in Tables 1 to 4, the addition of 0.10 weight percent acid polymer with 3-MPA provides an effective copper removal rate with low dishing. Furthermore, the acidic polymer facilitates these polishing attributes in combination with effective copper residue clearing.

1. An aqueous abrasive-free composition useful for chemical mechanical polishing of a patterned semiconductor wafer containing a nonferrous metal comprising an oxidizer, an inhibitor for the nonferrous metal, 0 to 15 weight percent water soluble modified cellulose, 0 to 15 weight percent phosphorus compound, 0.005 to 5 weight percent of an acidic polymer, the acidic polymer having a methacrylic acid portion, the methacrylic acid portion having a carbon number of 4 to 250, the methacrylic acid portion including either methacrylic acid or an acrylic acid/methacrylic acid copolymer, the acidic polymer including a segment from a chain transfer agent, the chain transfer agent being a mercapto-carboxylic acid, and water.

2. The composition of claim 1 wherein the acidic polymer has a number average molecular weight of 170 to 7,500.

3. The composition of claim 2 wherein the chain transfer agent is 3-mercaptopropionic acid.

4. The composition of claim 1 wherein the methacrylic acid portion is an acrylic/methacrylic acid copolymer.

5. The composition of claim 1 wherein the methacrylic acid portion is a polymethacrylic acid.

6. An aqueous abrasive-free composition useful for chemical mechanical polishing of a patterned semiconductor wafer containing a nonferrous metal comprising 0.1 to 25 weight percent oxidizer, 0.05 to 15 weight percent inhibitor for the nonferrous metal, 0.01 to 5 weight percent water soluble modified cellulose, 0.01 to 10 weight percent phosphorus compound, 0.01 to 3 weight percent of an acidic polymer, the acidic polymer having a methacrylic acid portion, the methacrylic acid portion having a carbon number of 7 to 100, the methacrylic acid portion including either methacrylic acid or an acrylic acid/methacrylic acid copolymer, the acidic polymer having a number average molecular weight of 200 to 6,000 and including a segment from a chain transfer agent, the chain transfer agent being a mercapto-carboxylic acid, and water.

7. The composition of claim 6 wherein the acidic polymer has a number average molecular weight of 500 to 5,000.

8. The composition of claim. 6 wherein the chain transfer agent is 3-mercaptopropionic acid.

9. The composition of claim 6 wherein the copolymer portion is an acrylic/methacrylic acid copolymer.

10. The composition of claim 6 wherein the methacrylic acid portion is a polymethacrylic acid.
